(19) United States
(12) Patent Application Publication
(10) Pub. No.: US 2025/0269443 A1
(43) Pub. Date: Aug. 28, 2025

(54) Replaceable Cutting Head Having Mounting Portion with Driven Projections, Tool Holder and Rotary Cutting Tool

(71) Applicant: ISCAR, LTD., TEFEN (IL)

(72) Inventor: SHIM’ON SHITRIT, KIBBUTZ METSUBA (IL)

(73) Assignee: ISCAR, LTD., TEFEN (IL)

(21) Appl. No.: 19/012,215

(22) Filed: Jan. 7, 2025

Related U.S. Application Data
(60) Provisional application No. 63/558,764, filed on Feb. 28, 2024.

(51) Int. Cl. B23C 5/20

(52) U.S. Cl. CPC B23C 5/20

(57) ABSTRACT

A cutting tool includes a cutting head including a rearward mounting portion and a head through hole. The mounting portion includes a male coupling member having a non-cylindrical, conically shaped head abutment surface, and at least two driven projections. The cutting tool includes a tool holder having a holder pocket which includes a female coupling member having a non-cylindrical, conically shaped forward holder abutment surface, at least two driving recesses and an internal threaded hole. In a locked position, the male coupling member is removably retained in the female coupling member by a fastening screw located in the head through hole and threadingly engaged with the holder internal threaded hole. The head abutment surface abuts the forward holder abutment surface thereby forming a secure coupling between the male and female coupling members. The driven projections are located in the driving recesses for providing torque transfer between the two parts.

### RELATED APPLICATIONS

The present application claims priority to U.S. Provisional Patent Application No. 63/558,764 filed 2024 Feb. 28. The contents of the aforementioned application are incorporated by reference in their entirety.

### FIELD OF THE INVENTION

The subject matter of the present application relates to rotary cutting tools of the type in which a replaceable cutting head, having a male coupling member, is removably retained in a female coupling member of a tool holder, by means of a coupling mechanism having a taper. More particularly it pertains to a coupling mechanism which also has at least two inter-engaged projections and recesses, for torque transfer, and yet further in particular where the coupling mechanism has an additional fastening screw.

### BACKGROUND OF THE INVENTION

Rotary cutting tools can be provided with a coupling mechanism for releasably retaining a replaceable cutting head within a tool holder by a fastening screw. An example of such a rotary cutting tool is disclosed in, for example, U.S. Pat. No. 7,431,543, showing a machine reamer which includes a base and an interchangeable reamer head assembled on the base. The reamer head is clamped with a conical shoulder into a complementary face-side insert seat of the base by means of a tension rod to provide the necessary coaxiality. The tension rod has a complementary polygonal section extending through an axis-central polygonal opening of the indexable head, so that a good rotational catch is guaranteed.

Another example is U.S. Pat. No. 7,004,692 showing a cutting head, a screw member and a tool shank. The screw member is in threaded engagement with the tool shank. The cutting head is centered with respect to the tool shank with a conical portion of the cutting head located in a conical forward portion of the tool shank. The cutting head has a head bore having a plurality of locking wings and the screw member has a plurality of clamping wings. Rotational coupling between the cutting head and the screw member is obtained by the engagement of the clamping wings of the screw member and stoppers which protrude forwardly in the axial direction from the locking surfaces of the locking wings. That is to say, torque is transferred from the tool shank to the head via the clamping wings on the screw member.

Yet another example is U.S. Pat. No. 9,919,366 showing a cutting insert having a first coupling structure, a tool holder having a complementary second coupling structure with a seat for a milling tool system, and a milling tool system. The first coupling structure has a circular cylindrical element with a cylinder abutment surface, the circular cylindrical element projecting axially from a bottom surface of a central body and being arranged concentrically with respect to a central axis. A perpendicular abutment surface is arranged perpendicular to the central axis, and at least two ribs project axially from the bottom surface. The ribs are symmetrical with two convexly curved flank surfaces which serve as driven surfaces. Each rib has a contact area with a normal direction at least essentially perpendicular to the central axis for opposing a torque about the central axis.

It is an object of the subject matter of the present application to provide a coupling mechanism of a replaceable cutting head in a tool holder which is suitable, in particular, for rotary cutting tools having a small outer cutting diameter.

### SUMMARY OF THE INVENTION

In accordance with a first aspect of the subject matter of the present application there is provided a replaceable cutting head, for rotary cutting operations, having a head central axis, defining opposite forward and rearward directions, and opposite rotationally forward and rearward directions with the rotationally forward direction being the cutting direction, the replaceable cutting head comprising:
a forward portion forming a cutting portion and a rearward portion forming a mounting portion; and
opposite head forward and rearward surfaces and a head peripheral surface extending therebetween, the head forward surface being located at the cutting portion and the head rear surface being located at the mounting portion;
a head through hole comprising a through hole peripheral surface which extends about a through hole central axis, and intersects the head forward and rearward surfaces; wherein:
   the mounting portion comprises:
      a male coupling member protruding rearwardly from a head base surface, the head base surface extending transversely with respect to the head central axis, and defining a boundary between the cutting portion and the mounting portion; and
      at least two angularly spaced apart driven projections projecting from the head rearward surface, each driven projection comprising a projecting wall comprising two opposite and angularly spaced apart projection flank surfaces, including a rotationally leading and a rotationally trailing projection flank surface, the rotationally trailing projection flank surface comprising a driven surface, for opposing a torque about the head central axis; wherein:
         the head base surface comprises a head axial abutment surface; and
         the male coupling member comprises a non-cylindrical, conically shaped head abutment surface.

In accordance with a further aspect of the subject matter of the present application, there is also provided a tool holder, having a holder longitudinal axis defining opposite forward and rearward directions, and opposite rotationally forward and rearward directions with the rotationally forward direction being the cutting direction, the tool holder comprising a holder pocket extending rearwardly from a holder forward surface, the holder forward surface extending transversely with respect to the holder longitudinal axis; wherein:
the holder pocket comprises:
   a female coupling member recessed in the holder forward surface, female coupling member comprising:
      a non-cylindrical, conically shaped holder abutment surface; and
      a female member bottom surface;
   at least two angularly spaced apart driving recesses recessed in the female member bottom surface, each driving recess comprising a recess circumferential wall comprising two opposite and angularly spaced apart recess flank surfaces including a rotationally leading and a rotationally trailing recess flank surface, the rotationally trailing recess flank surface comprising a driving surface, for providing a torque about the holder longitudinal axis; and
   a holder internal threaded hole recessed in the female member bottom surface; wherein:
      the holder forward surface comprises a holder axial abutment surface.

In accordance with a yet further aspect of the subject matter of the present application, there is also provided a rotary cutting tool comprising:
a replaceable cutting head of the type described above;
a tool holder of the type described above; and
a fastening screw; wherein:
   the male coupling member is located in the female coupling member, with the head abutment surface abutting the holder abutment surface;
   each driven projection is located in a respective driving recess, with the driven surface abutting the driving surface; and
   the replaceable cutting head is removably attached to the tool holder by the fastening screw located in the head through hole and being threadingly engaged with the holder internal threaded hole.

It is understood that the above-said is a summary, and that features described hereinafter may be applicable in any combination to the subject matter of the present application, for example, any of the following features may be applicable to the replaceable cutting head, the tool holder or the rotary cutting tool:

Each projecting wall can further comprise opposite radially outward and inward projection surfaces which connect the rotationally leading trailing projection flank surface. The radially outward and inward projection surfaces can merge smoothly with the conically shaped head abutment surface and the through hole peripheral surface, respectively.

Each driven surface can be planar.

The head rearward surface can define a head rearward plane oriented perpendicular to the head central axis. Each planar driven surface can form an external driven axial angle with the head rearward plane. The driven axial angle can fulfill the condition: 100°≤ρ1≤130°.

The driven axial angle can fulfill the condition: μ1=115°.

In a cross-sectional view of the replaceable cutting head taken in a head radial plane oriented perpendicular to the head central axis and extending through a given driven surface, the given driven surface can define an imaginary straight driven line which intersects the head through hole.

The given driven surface can comprise a radially outermost driven point and a radially innermost driven point, the radially outermost driven point being angularly offset from the radially innermost driven point, relative to the head central axis, by a non-zero acute driven offset angle. An imaginary straight driven radial line can extend from the head central axis and intersect the radially outermost driven point, the imaginary straight driven radial line forming a non-zero acute driven radial angle with the given driven surface.

The head radial plane can extend through a forwardmost portion of the given driven surface. The driven radial angle can fulfill the condition: 15°≤ε1≤25°.

The radially outermost driven point can be angularly offset from the radially innermost driven point, relative to the head central axis, in the rotationally forward direction.

The head axial abutment surface can be planar and oriented perpendicular to the head central axis. The head axial abutment surface can extend entirely circumferentially about the male coupling member.

The at least two driven projections can be identical.

The male coupling member can comprise exactly two angularly spaced apart driven projections.

Each driven projection can subtend a maximum projection angle at the head central axis. The maximum projection angle can fulfill the condition: 100°≤θ1≤130°.

The head abutment surface can taper inwardly in the rearward direction at a head cone angle. The head cone angle can be in the range of 5.5°≤2α≤6.5°.

The head cone angle can be in the range of 5.9°≤2α≤6.1°.

The cutting portion can comprise at least two peripheral cutting edges defining an outer cutting diameter. The outer cutting diameter can fulfill the condition: 6 mm<O<8 mm.

The driven projections can have a projection height as measured in a direction along the head central axis. The male coupling member can have a male coupling member height as measured between the head rearward surface and the head base surface in the direction along the head central axis. The projection height can fulfill the condition: 0.25H′≤H≤0.50H′.

The cutting portion can have a cutting portion height as measured between the head forward surface and the head base surface in the direction along the head central axis. The male coupling member height can be less than the cutting portion height.

Each recess circumferential wall can further comprise a radially outward recess surface which connects the rotationally leading and trailing recess flank surfaces. The radially outward recess surface can extend to, and merge smoothly with, the conically shaped holder abutment surface. Each driving recess can open out to the holder internal threaded hole at a radially inward recess opening opposite the radially outward recess surface.

Each driving surface can be planar.

The female member bottom surface can define a female member bottom plane oriented perpendicular to the holder longitudinal axis. Each planar driving surface can form an internal driving axial angle with the female member bottom plane. The driving axial angle can fulfill the condition: 100°≤μ2≤130°.

The driving axial angle can fulfill the condition: μ2=115°.

In a cross-sectional view of the tool holder taken in a holder radial plane oriented perpendicular to the holder longitudinal axis and extending through a given driving surface, the given driving surface can define an imaginary straight driving line which intersects the holder internal threaded hole.

The given driving surface can comprise a radially outermost driving point and a radially innermost driving point, the radially outermost driving point being angularly offset from the radially innermost driving point, relative to the holder longitudinal axis, by a non-zero acute driving offset angle. An imaginary straight driving radial line can extend from the head central axis and intersect the radially outermost driving point, the imaginary straight driving radial line forming a non-zero acute driving radial angle with the given driving surface.

The holder radial plane can extend through a forwardmost portion of the given driving surface. The driving radial angle can fulfill the condition: 15°≤ε2≤25°.

The radially outermost driving point can be angularly offset from the radially innermost driving point, relative to the holder longitudinal axis, in the rotationally forward direction.

The holder axial abutment surface can be planar and oriented perpendicular to the holder longitudinal axis. The holder axial abutment surface can extend entirely circumferentially about the female coupling member.

The at least two driving recesses can be identical.

The holder pocket can comprise exactly two angularly spaced apart driving recesses.

Each driving recess can subtend a maximum recess angle at the holder longitudinal axis. The recess angle can fulfill the condition: 100°≤θ2≤130°.

The holder abutment surface can taper inwardly in the rearward direction, at a holder cone angle. The holder cone angle can be in the range of 5.5°≤2γ≤6.5°.

The holder cone angle can be in the range of 5.9°≤2γ≤6.1°.

Each driving recess comprises a recess bottom surface bounded by the recess circumferential wall.

The driving recesses can have a recess depth as measured in a direction along the holder longitudinal axis. The female coupling member can have a female coupling member depth as measured between the holder forward surface and the female member bottom surface in the direction along the holder longitudinal axis. The recess depth can fulfill the condition: 0.25D′≤D≤0.50D′.

In a locked position of the cutting tool, the head axial abutment surface can abut the holder axial abutment surface.

In a locked position of the cutting tool, each rotationally leading projection flank surface can be spaced apart from a respective rotationally leading recess flank surface.

In a locked position of the cutting tool, the head rearward surface can be spaced apart from the female member bottom surface.

The rotary cutting tool can be a reamer.

### BRIEF DESCRIPTION OF THE FIGURES

For a better understanding of the present application and to show how the same may be carried out in practice, reference will now be made to the accompanying drawings, in which:

FIG. 1 is a perspective view of a rotary cutting tool;

FIG. 2 is an exploded perspective view of the rotary cutting tool shown in FIG. 1;

FIG. 3 is a perspective view of a replaceable cutting head shown in FIGS. 1 and 2;

FIG. 4 is a side view of the replaceable cutting head shown in FIG. 3;

FIG. 5 is another side view of the replaceable cutting head shown in FIG. 3;

FIG. 6 is a cross-sectional view of the replaceable cutting head taken along the line VI-VI in FIG. 5;

FIG. 6A is detail of FIG. 6;

FIG. 7 is a rearward view of the replaceable cutting head shown in FIG. 3;

FIG. 8 is a cross-sectional view of the replaceable cutting head taken along the line VIII-VIII in FIG. 7;

FIG. 9 is a forward view of the replaceable cutting head shown in FIG. 3;

FIG. 10 is a perspective view of a forward end of a tool holder shown in FIGS. 1 and 2, in front of a holder pocket;

FIG. 11 is a forward view of the tool holder shown in FIG. 10;

FIG. 12 is a cross-sectional view of the tool holder taken along the line XII-XII in FIG. 11;

FIG. 13 is a side view of the tool holder shown in FIG. 10;

FIG. 14 is a cross-sectional view of the tool holder taken along the line XIV-XIV in FIG. 13;

FIG. 14A is detail of FIG. 14;

FIG. 15 is a forward view of the rotary cutting tool shown in FIGS. 1 and 2;

FIG. 16 is a cross-sectional view of the rotary cutting tool taken along the line XVI-XVI in FIG. 15;

FIG. 17 is a side view of the rotary cutting tool shown in FIG. 15; and

FIG. 18 is a cross-sectional view of the rotary cutting tool taken along the line XVIII-XVIII in FIG. 17.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

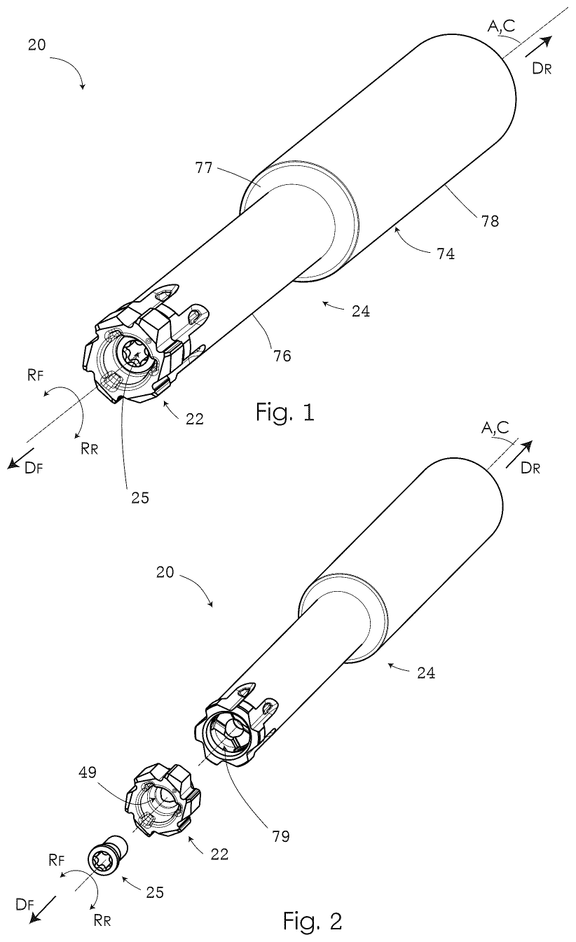

Attention is first drawn to FIGS. 1 and 2 showing a rotary cutting tool 20 of the type used for reaming operations, in accordance with embodiments of the subject matter of the present application. The rotary cutting tool 20 includes a replaceable cutting head 22 that has a head central axis A, around which the replaceable cutting head 22 rotates defining opposite rotationally forward and rearward directions R_{F}, R_{R}. The rotationally forward direction R_{F} is the cutting direction. The head central axis A also defines opposite forward and rearward directions D_{F}. D_{R}. Stated differently, the head central axis A extends in a forward D_{F} to rearward direction D_{R}. The replaceable cutting head 22 can be typically made from cemented carbide. The rotary cutting tool 20 also includes a tool holder 24. The tool holder 24 can be typically made from steel. The replaceable cutting head 22 can be removably retained in the tool holder 24 by means of a tapered coupling mechanism and a fastening screw 25. Such couplings could possibly be advantageous for other types of rotary cutting operations than that stated hereinabove, such as, for example, milling or drilling.

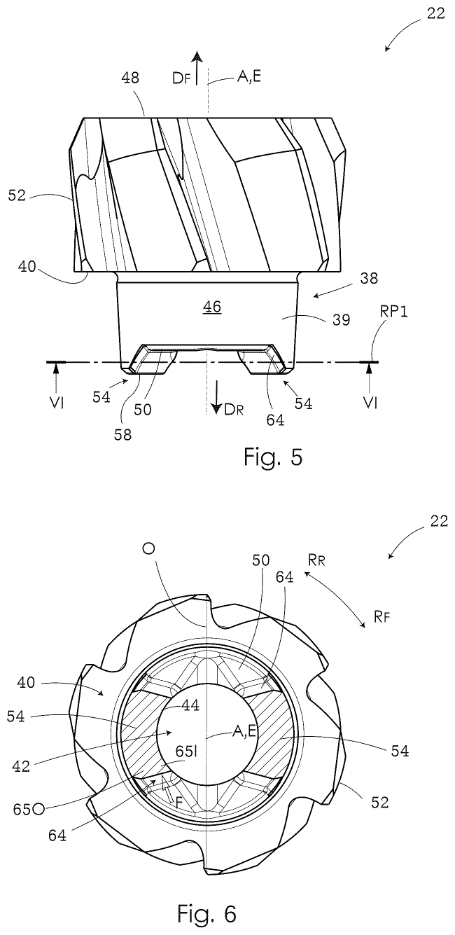

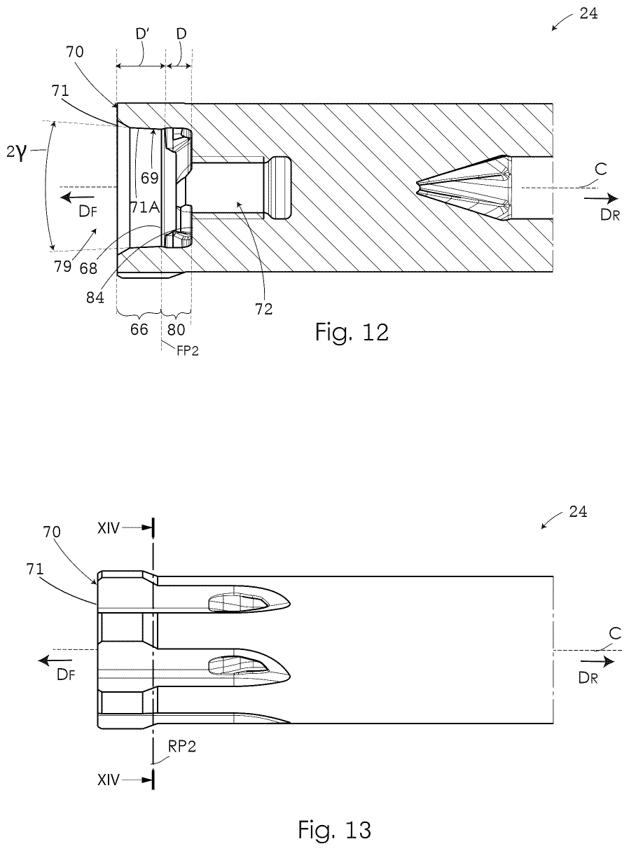

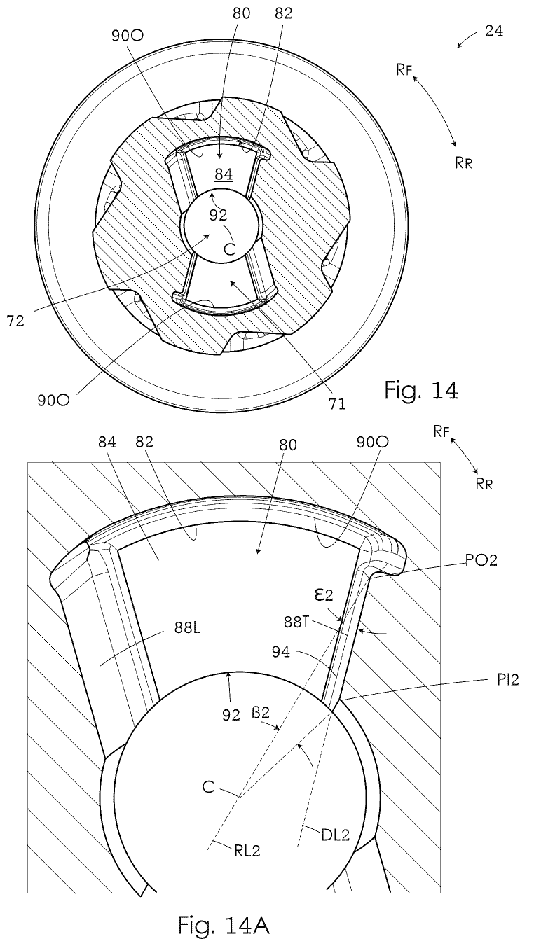

It should be appreciated that use of the terms “forward” and “rearward” throughout the description and claims when referring to the cutting head 22 relate to a relative position in a direction of the head central axis A towards the top and bottom of the page, respectively, in FIGS. 4 and 5. Likewise, when referring to the tool holder 24 the two terms relate to a relative position in a direction of the holder longitudinal axis C towards the left and right of the page, respectively, in FIGS. 12 and 13. It should be further appreciated that use of the terms “rotationally forward” and “rotationally rearward” throughout the description and claims refer to a relative position in a rotational direction about the head central axis A counter-clockwise and clockwise, respectively, in FIG. 9. Likewise, when referring to the tool holder 24 the two terms relate to a relative position in a rotational direction about the holder longitudinal axis C counterclockwise and clockwise, respectively, in FIG. 14.

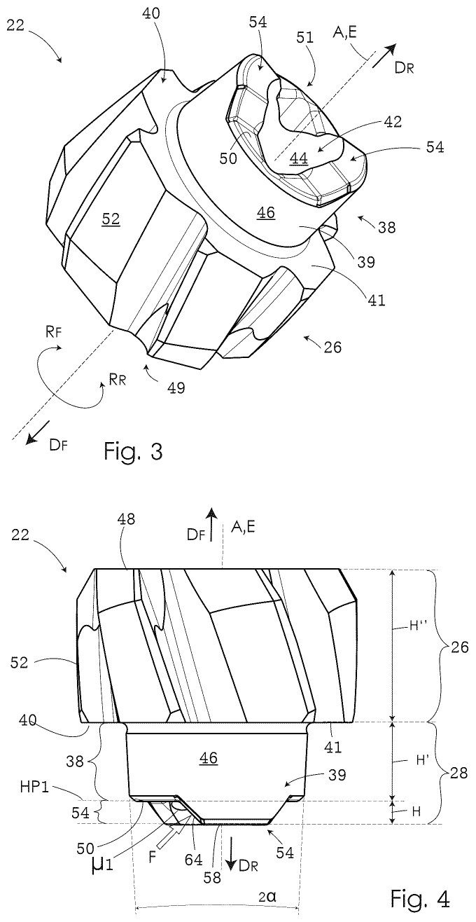

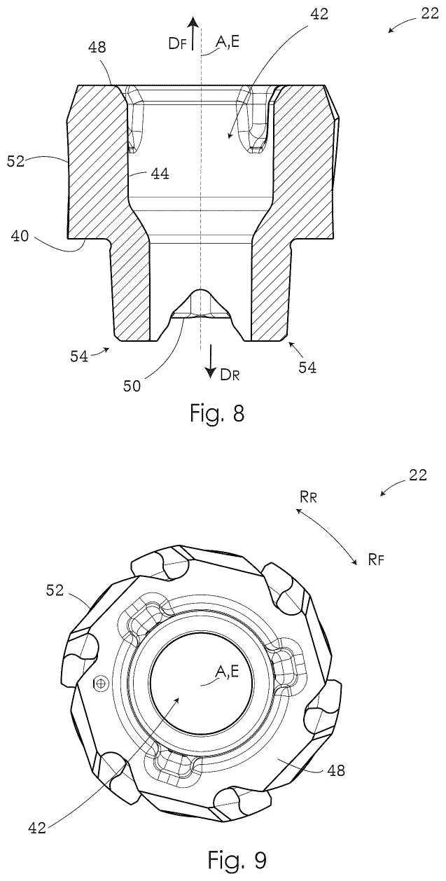

Reference is now made to FIGS. 3 to 9. The replaceable cutting head 22 has a forward portion that forms a cutting portion 26 and a rearward portion that forms a mounting portion 28. That is to say, the cutting portion 26 is forwardly disposed and the mounting portion 28 is rearwardly disposed. In accordance with some embodiments of the subject matter of the present application, the cutting portion 26 can adjoin the mounting portion 28.

Referring to FIG. 4, the replaceable cutting head 22 includes opposite head forward and rearward surfaces 48, 50 and a head peripheral surface 52 extending therebetween. The head forward surface 48 is located at the cutting portion 26 and faces generally in the forward direction D_{F}. The head rearward surface 50 is located at the mounting portion 28 and faces generally in the rearward direction D_{R}. The head peripheral surface 52 extends about the head central axis A. In accordance with some embodiments of the subject matter of the present application, the head rearward surface 50 can define a head rearward plane HP1 oriented perpendicular to the head central axis A. The head rearward surface 50 can lie in the head rearward plane HP1.

In accordance with some embodiments of the subject matter of the present application the replaceable cutting head 22 can be integrally formed to have unitary one-piece construction. This provides an advantage in that the replaceable cutting head 22 has no detachable cutting inserts (not shown). Such detachable cutting inserts need to be replaced periodically and this can be a time-consuming procedure. There is also a possibility that threaded screws (not shown), for example, which can be used to releasably retain the detachable cutting inserts to the replaceable cutting head 22 can be mislaid and/or lost during the replacement operation.

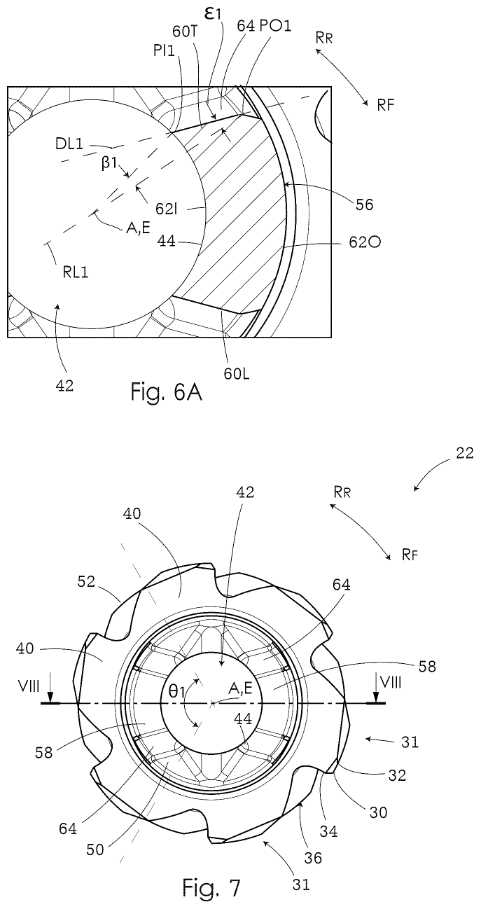

Referring to FIGS. 6 and 7, the cutting portion 26 includes at least one peripheral cutting edge 30. In this non-limiting example shown in the drawings, there can be exactly six peripheral cutting edges. The peripheral cutting edges 30 define an outer cutting diameter O. The outer cutting diameter O can be greater than or equal to 6 mm and less than or equal to 8 mm. The outer cutting diameter O can exactly equal to 6 mm. Each peripheral cutting edge 30 is formed at the intersection of a peripheral relief surface 32, and a peripheral rake surface 34. The peripheral relief surface 32 is located rotationally rearward of (i.e., behind) the peripheral cutting edge 30 and the peripheral rake surface 34 is located rotationally forward of (i.e., ahead) of the peripheral cutting edge 30. Generally speaking, the peripheral rake surface 34 faces in the rotationally forward direction R_{F}. The orientation of the peripheral cutting edge 30 (and the peripheral rake and relief surfaces 34, 32) allows metal cutting operations to be performed. In accordance with some embodiments of the subject matter of the present application the cutting portion 26 can include at least one flute 36 for evacuating chips (not shown) that are produced during the cutting operation. One flute 36 is associated with each peripheral cutting edge 30. As seen in the figures, the cutting portion 26 includes a plurality circumferentially arranged cutting sections 31, each cutting section 31 including in the rotationally forward direction R_{F}, a trailing relief surface 32, a cutting edge 30, a rake surface 34 and a flute 36, one after another.

Making reference in particular to FIG. 4, the mounting portion 28 includes a male coupling member 38 that protrudes rearwardly from a head base surface 40. The head base surface 40 extends transversely with respect to the head central axis A and defines a boundary between the cutting portion 26 and the mounting portion 28. That is to say, the cutting portion 26 is formed forward of the head base surface 40 and the mounting portion 28 is formed rearward of the head base surface 40. In accordance with some embodiments of the subject matter of the present application the male coupling member 38 can be rigid. It is noted that the male coupling member 38 can be delimited in the rearward direction D_{R} by the head rearward surface 50.

The head base surface 40 can include a head axial abutment surface 41, for abutment with a corresponding surface on the tool holder 24, thereby allowing precise axial seating of the cutting head 22 in the tool holder 24. In accordance with some embodiments of the subject matter of the present application, the head axial abutment surface 41 can be planar and oriented perpendicular to the head central axis A. Referring to FIG. 3, the head axial abutment surface 41 can extend entirely circumferentially about the male coupling member 38.

The male coupling member 38 includes a male member peripheral surface 39 which extends between the head base surface 40 and the head rearward surface 50. The male member peripheral surface 39 extends about the head central axis A.

Referring again to FIG. 4, the cutting portion 26 has a cutting portion height H″ as measured between the head forward surface 48 and the head base surface 40 in a direction along the head central axis A. The male coupling member 38 has a male coupling member height H′ as measured between the head rearward surface 50 and the head base surface 40 in the direction along the head central axis A. In accordance with some embodiments of the subject matter of the present application, the male coupling member height H′ can be less than the cutting portion height H″.

Referring to FIG. 4, the male coupling member 38 includes a circumferentially extending head abutment surface 46 that extends about the head central axis A. The head abutment surface 46 is located on the male member peripheral surface 39. The head abutment surface 46 faces radially outwardly. The head abutment surface 46 tapers inwardly in the rearward direction D_{R} at a head cone angle 2α. That is to say, the head abutment surface 46 has a non-cylindrical, conical shape facing radially outwards, where the head cone angle 2α is an internal angle. In accordance with some embodiments of the subject matter of the present application, the head abutment surface 46 can be frusto-conical. The head cone angle 2α can be in the range of 5.5°≤2α≤6.5°. Stated differently, the head abutment surface 46 can define a taper angle α which is in the range of 2.75°≤α≤3.25° with respect to the head central axis A (the taper angle α being half the cone angle 2α). Preferably, the head cone angle 2α can be in the range of 5.9°≤2α≤6.1°. Further preferably, the head cone angle 2α can equal 6°. It is noted that the head abutment surface 46 is intended to abut a corresponding surface on the tool holder 24 when the rotary cutting tool 20 is in a locked position, as will be described hereinafter. The conically shaped head abutment surface 46 acts to center the cutting head 22 in the tool holder 24. The head abutment surface 46 can extend axially between the head base surface 40 and the head rearward surface 50.

It should be appreciated that use of the terms “radially inward/inwardly” and “radially outward/outwardly” throughout the description and claims refer to a relative position in a perpendicular direction in relation to the head central axis A and/or holder longitudinal axis C, towards and away from the respective axis, in FIGS. 4 to 9, and 10 to 12. It should further be appreciated that use of the term “cone angle” throughout the description refers to an angle formed by the tapered surfaces of a cone, in a longitudinal cross-section. It is noted that the term “longitudinal cross-section” refers to a cross-section taken in a plane containing the longitudinal axis.

Referring in general to FIGS. 2-9, the replaceable cutting head 22 includes a head through hole 42, which extends through the cutting and mounting portions 26, 28. The head through hole 42 is configured for the fastening screw 25 to be inserted therethrough, as described later in the description. The head through hole 42 includes a through hole peripheral surface 44 which extends about a through hole central axis E. Generally speaking, the through hole peripheral surface 44 faces towards the through hole central axis E. The through hole peripheral surface 44 intersects the head forward and rearward surfaces 48, 50. That is to say, the head through hole 42 opens out to the head forward and rearward surfaces 48, 50 (at head forward and rearward hole openings 49, 51, respectively). In accordance with some embodiments of the subject matter of the present application, the head forward and rearward hole openings 49, 51 can be intersected by the head central axis A. The through hole central axis E can be co-incident with the head central axis A. It is noted that the head through hole 42 can be devoid of an internal thread.

As seen in FIGS. 3 and 7, the mounting portion 28 includes at least two angularly spaced apart driven projections 54 which project from the head rearward surface 50. In accordance with some embodiments of the subject matter of the present application, the at least two driven projections 54 can be identical. In some embodiments, the male coupling member 38 can include exactly two angularly spaced apart driven projections 54.

The following disclosure refers to one of the driven projections 54 but is applicable to all other driven projections 54.

Referring to FIG. 4, the driven projection 54 has a projection height H, as measured in the direction along the head central axis A (between the head rearward surface 50 and a projection top surface 58, described below). The projection height H can be greater than or equal to 25% of the male coupling member height H′ and less than or equal to 50% of the male coupling member height H′ (i.e., 0.25H′≤H≤0.50H′).

Referring to FIGS. 6A and 7, the driven projection 54 includes a projecting wall 56 and the projection top surface 58 bounded by the projecting wall 56. The projecting wall 56 includes two opposite and angularly spaced apart projection flank surfaces 60L, 60T. That is, the two opposite projection flank surfaces 60L, 60T include a rotationally leading and a rotationally trailing projection flank surface 60L, 60T (the rotationally leading projection flank surface 60L being rotationally forward of the rotationally trailing projection flank surface 60T). The projecting wall 56 includes opposite radially inward and outward projection surfaces 62I, 62O which connect the rotationally leading and trailing projection flank surfaces 60L, 60T. In accordance with some embodiments of the subject matter of the present application, the radially outward projection surface 62O can merge smoothly with the conically shaped head abutment surface 46. For instance, the radially outward projection surface 62O may lay on the same imaginary conical surface as the conically shaped head abutment surface 46. Likewise, the radially inward projection surface 62I can merge smoothly with the through hole peripheral surface 44. Thus, the inward projection surface 62I may lay on the same imaginary cylindrical surface as the through hole peripheral surface 44, or even be considered an extension of the latter.

The rotationally trailing projection flank surface 60T includes a driven surface 64, for opposing a torque about the head central axis A. In accordance with some embodiments of the subject matter of the present application, the driven surface 64 can be planar. A planar driven surface 64 may be more efficient at torque transfer than a convexly curved driven surface due to more complete contact with a complementary driving surface. As seen in the figures, driven surfaces 64 are located at the rearwardmost portion of the cutting head 22 and constitute the only torque-receiving surfaces formed on the cutting head 22. As such, no driven surfaces are present in the cutting portion 26 of the cutting head 22. Furthermore, the entire cutting head 22 with its driven surfaces 64 has monolithic (unitary, one-piece) construction.

Reverting to FIG. 4, in accordance with some embodiments of the subject matter of the present application, the planar driven surface 64 can form an external driven axial angle μ1 with the head rearward plane HP1. The driven axial angle μ1 can fulfill the condition: 100°≤μ1≤130°. Preferably, the driven axial angle μ1 can fulfill the condition: 110°≤μ1≤120°. Further preferably, the driven axial angle μ1 can fulfill the condition: μ1=115°. A drive force F exerted by a driving surface 94 on each driving recess 80 (discussed further below) acts on the driven surface 64 on a respective driven projection 54 (in a direction normal to the driven surface 64). In extreme conditions said drive force F can cause the driven projection 54 to break (shear off). Forming the driven axial angle μ1 to be in the range of 100°≤μ1≤130° has been found to advantageously reduce the possibility of breakage by directing the drive force F upwards towards the male coupling member 38, such that the driven projection 54 is supported/strengthened by the male coupling member 38 (against said drive force F). Moreover, having the driven axial angle μ1 less than 130° ensures that the driven surface 64 does not slip against the driving recess 80. It should be appreciated that throughout the detailed description and claims, an “internal angle” refers to an angle between two surface components of a member surface as measured internal to the member, whereas an “external angle” refers to an angle between two surface components of a member surface as measured external to the member.

Reverting to FIGS. 6 and 6A, in accordance with some embodiments of the subject matter of the present application, in a cross-sectional view of the replaceable cutting head 22 taken in a head radial plane RP1 oriented perpendicular to the head central axis A and extending through a given driven surface 64, the given driven surface 64 defines an imaginary straight driven line DL1 which may intersect the head through hole 42.

In accordance with some embodiments of the subject matter of the present application, the given driven surface 64 can include a radially outermost driven point PO1 and a radially innermost driven point PI1. The radially outermost driven point PO1 can be angularly offset from the radially innermost driven point PI1, relative to the head central axis A, by a non-zero acute driven offset angle β1. Thus, the straight driven line DL1 may not intersect the head central axis A. The radially outermost driven point PO1 can be angularly offset, relative to the head central axis A, from the radially innermost driven point PI1 in the rotationally forward direction R_{F}. The driven offset angle β1 can fulfill the condition: 10°≤β1≤15°. Forming the driven offset angle β1 to be in this range has been found advantageous for strengthening a radially outer corner portion 650 (formed at the intersection of the radially outward projection surface 62O and the rotationally trailing projection flank surface 60T) of each driven projection 54 against the drive force F, while maintaining sufficient strength at a radially inner corner portion 65I (formed at the intersection of the radially inward projection surface 62I and the rotationally trailing projection flank surface 60T) of the same driven projection 54 (see FIG. 6). Additionally, the contact area between the driven projection 54 and the driving recess 80 is increased (compared to when β1=0), which is particularly desirable for small diameter tools where contact region is correspondingly small.

An imaginary straight driven radial line RL1 extends from the head central axis A and intersects the radially outermost driven point PO1. In accordance with some embodiments of the subject matter of the present application, the imaginary straight driven radial line RL1 forms a non-zero acute driven radial angle ε1 with the given driven surface 64. The head radial plane RP1 can extend through a forwardmost portion of the given driven surface 64 and the driven radial angle ε1 can fulfill the condition: 15°≤ε1≤25°.

Making reference to FIG. 7, each driven projection 54 subtends a maximum projection angle θ1 at the head central axis A. In accordance with some embodiments of the subject matter of the present application, the maximum projection angle θ1 can fulfill the condition: 100°≤θ1≤130°. In this non-limiting example shown in the drawings, the maximum projection angle θ1 is defined by the forwardmost portions of the two angularly spaced apart projection flank surfaces 60L, 60T.

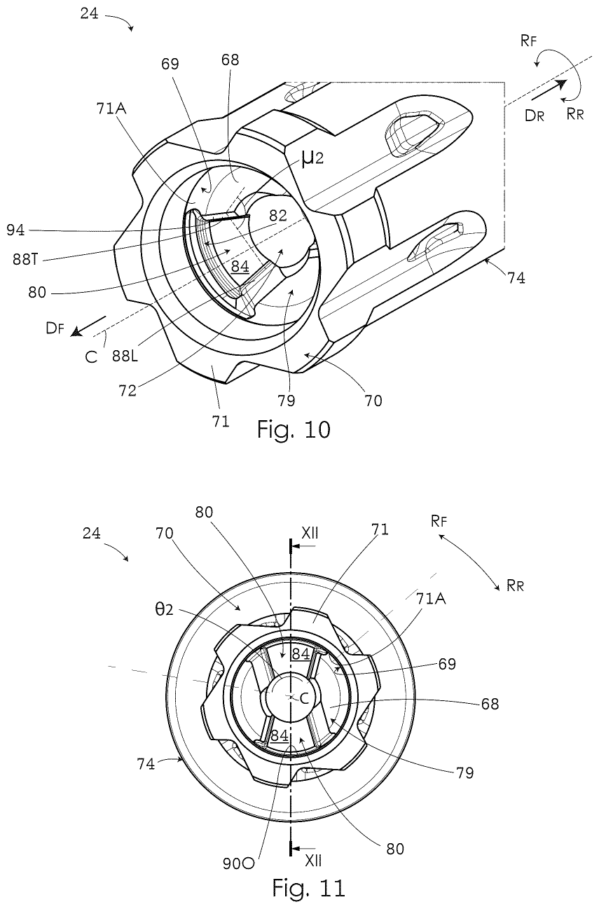

Another aspect of the subject matter of the present application relates to the tool holder 24. Referring now to FIGS. 10-14A, the tool holder 24 has a holder longitudinal axis C, around which the tool holder 24 rotates defining opposite rotationally forward and rearward directions R_{F}, R_{R}. The rotationally forward direction R_{F} is the cutting direction. The holder longitudinal axis C also defines opposite forward and rearward directions D_{F}. D_{R}. In accordance with some embodiments of the subject matter of the present application, the tool holder 24 can include a holder peripheral surface 74 which extends about the holder longitudinal axis C and delimits a boundary of a holder forward surface 70. The holder forward surface 70 is located at a forward end of the tool holder 24. The holder forward surface 70 extends transversely with respect to the holder longitudinal axis C. In accordance with some embodiments of the subject matter of the present application, the holder forward surface 70 can be perpendicular to the holder longitudinal axis C.

In accordance with some embodiments of the subject matter of the present application, the holder peripheral surface 74 can include a forward holder peripheral surface 76 and a rearward holder peripheral surface 78 and an intermediate holder peripheral surface 77 which extends therebetween. The forward holder peripheral surface 76 can be closer to the holder forward surface 70 than both the intermediate holder peripheral surface 77 and the rearward holder peripheral surface 78. The forward holder peripheral surface 76 and the rearward holder peripheral surface 78 lie on different imaginary co-axial cylinders. The forward holder peripheral surface 76 can have a diameter less than the diameter of the rearward holder peripheral surface 78. The intermediate holder peripheral surface 77 can slope radially outwardly from the forward holder peripheral surface 76 to the rearward holder peripheral surface 78.

The holder forward surface 70 can include a holder axial abutment surface 71, for abutment with a corresponding surface on the replaceable cutting head 22. In accordance with some embodiments of the subject matter of the present application, the holder axial abutment surface 71 can be planar and oriented perpendicular to the holder longitudinal axis C.

Referring to FIG. 12, the tool holder 24 includes a holder pocket 79 which extends rearwardly from the holder forward surface 70.

The holder pocket 79 includes a female coupling member 66 that is recessed in the holder forward surface 70. The holder axial abutment surface 71 can extend entirely circumferentially about the female coupling member 66.

The female coupling member 66 includes a female member bottom surface 68 and a female member peripheral surface 69 extending about the holder longitudinal axis C between the female member bottom surface 68 and the holder forward surface 70. The female member bottom surface 68 defines a female member bottom plane FP2 oriented perpendicular to the holder longitudinal axis C. The female member bottom surface 68 can lie in the female member bottom plane FP2.

Referring again to FIG. 12, the female coupling member 66 has a female coupling member depth D′ as measured between the holder forward surface 70 and the female member bottom surface 68 in the direction along the holder longitudinal axis C.

The female coupling member 66 includes a holder abutment surface 71A that extends about the holder longitudinal axis C. The holder abutment surface 71A is located on the female member peripheral surface 69. The holder abutment surface 71A faces inwardly with respect to the holder longitudinal axis C. The holder abutment surface 71A tapers inwardly in the rearward direction D_{R} at a holder cone angle 2γ. That is to say, the holder abutment surface 71A has a non-cylindrical, conical shape facing radially inwards, where the holder cone angle 2γ is an external angle. In accordance with some embodiments of the subject matter of the present application, the holder abutment surface 71A can be frusto-conical. The holder cone angle 2γ can be in the range of 5.5°≤2γ≤6.5°. Stated differently, the holder abutment surface 71A can define a taper angle γ which is in the range of 2.75°≤γ<3.25° with respect to the holder longitudinal axis C. Preferably, the holder cone angle 2γ can be in the range of 5.9°≤2γ≤6.1°. Further preferably, the holder cone angle 2γ can equal 6°. The holder abutment surface 71A can extend between the holder forward surface 70 and the female member bottom surface 68.

The holder pocket 79 includes a holder internal threaded hole 72 recessed in the female member bottom surface 68 and extending along the holder longitudinal axis C. The holder internal threaded hole 72 serves to threadingly receive the fastening screw 25 as described later in the description. As seen in, e.g., FIG. 12, the holder internal threaded hole 72 is a blind hole, and thus does not axially extend through the body of the tool holder to the latter's rear end.

Reverting to FIG. 10, the holder pocket 79 includes at least two angularly spaced apart driving recesses 80 which are recessed in the female member bottom surface 68. The number of driving recesses 80 matches the number of the driven projections 54. The at least two angularly spaced apart driving recesses 80 are designed for the at least two driven projections 54 to be inserted therein. In accordance with some embodiments of the subject matter of the present application, the at least two driving recesses 80 can be identical. In some embodiments, the holder pocket 79 can include exactly two angularly spaced apart driving recesses 80.

The following disclosure refers to one of the driving recesses 80 but is applicable to all other driving recesses 80.

The driving recess 80 has a recess depth D (see FIG. 12), as measured in the direction along the holder longitudinal axis C (between the female member bottom surface 68 and a recess bottom surface 84, described below). The recess depth D can be greater than or equal to 25% of the female coupling member depth D′ and less than or equal to 50% of the female coupling member depth D′ (i.e., 0.25D′≤D≤0.50D′).

As shown in FIGS. 14 and 14A, the driving recess 80 includes a recess circumferential wall 82 and a recess bottom surface 84 bounded by the recess circumferential wall 82. The recess circumferential wall 82 includes two opposite and angularly spaced apart recess flank surfaces 88L, 88T. That is, the two opposite recess flank surfaces 88L, 88T include a rotationally leading and a rotationally trailing recess flank surface 88L, 88T (the rotationally leading recess flank surface 88L being rotationally forward of the rotationally trailing recess flank surface 88T). In accordance with some embodiments of the subject matter of the present application, the recess circumferential wall 82 can also include a radially outward recess surface 90O which connects the rotationally leading and trailing recess flank surfaces 88L, 88T. The radially outward recess surface 90O can merge smoothly with the conically shaped holder abutment surface 71A. The driving recess 80 can open out to the holder internal threaded hole 72 at a radially inward recess opening 92 opposite the radially outward recess surface 90O.

The rotationally trailing recess flank surface 88T includes a driving surface 94, for providing a torque about the holder longitudinal axis C (to the driven surface 64). In accordance with some embodiments of the subject matter of the present application, the driving surface 94 can be planar.

Making reference to FIG. 10, in accordance with some embodiments of the subject matter of the present application, the planar driving surface 94 can form an internal driving axial angle μ2 with the female member bottom plane FP2. The driving axial angle μ2 can fulfill the condition: 100°≤μ2≤130°. Preferably, the driving axial angle μ2 can fulfill the condition: 110°≤μ2≤120°. Further preferably, the driving axial angle μ2 can fulfill the condition: μ2=115°.

Reverting to FIGS. 14 and 14A, in accordance with some embodiments of the subject matter of the present application, in a cross-sectional view of the tool holder 24 taken in a holder radial plane RP2 oriented perpendicular to the holder longitudinal axis C and extending through a given driving surface 94, the given driving surface 94 defines an imaginary straight driving line DL2 which may intersect the holder internal threaded hole 72.

In accordance with some embodiments of the subject matter of the present application, the given driving surface 94 can include a radially outermost driving point PO2 and a radially innermost driving point PI2. The radially outermost driving point PO2 can be angularly offset from the radially innermost driving point PI2, relative to the holder longitudinal axis C, by a non-zero acute driving offset angle β2. Thus, the straight driving line DL2 may not intersect the holder longitudinal axis C. The radially outermost driving point PO2 can be angularly offset from the radially innermost driving point PI2, relative to the holder longitudinal axis C, in the rotationally forward direction R_{F}. The driving offset angle β2 can fulfill the condition: 10°≤β2≤15°.

An imaginary straight driving radial line RL2 extends from the holder longitudinal axis C and intersects the radially outermost driving point PO2. In accordance with some embodiments of the subject matter of the present application, the imaginary straight driving radial line RL2 forms a non-zero acute driving radial angle ε2 with the given driving surface 94. The holder radial plane RP2 can extend through a forwardmost portion of the given driving surface 94 and the driving radial angle ε2 can fulfill the condition: 15°≤ε2≤25°.

Making reference to FIG. 11, each driving recess 80 subtends a maximum recess angle θ2 at the holder longitudinal axis C. In accordance with some embodiments of the subject matter of the present application, the maximum recess angle θ2 can fulfill the condition: 100°≤θ2≤130°. In this non-limiting example shown in the drawings, the maximum recess angle θ2 is defined by the forwardmost portions of the two angularly spaced apart recess flank surfaces 88L, 88T.

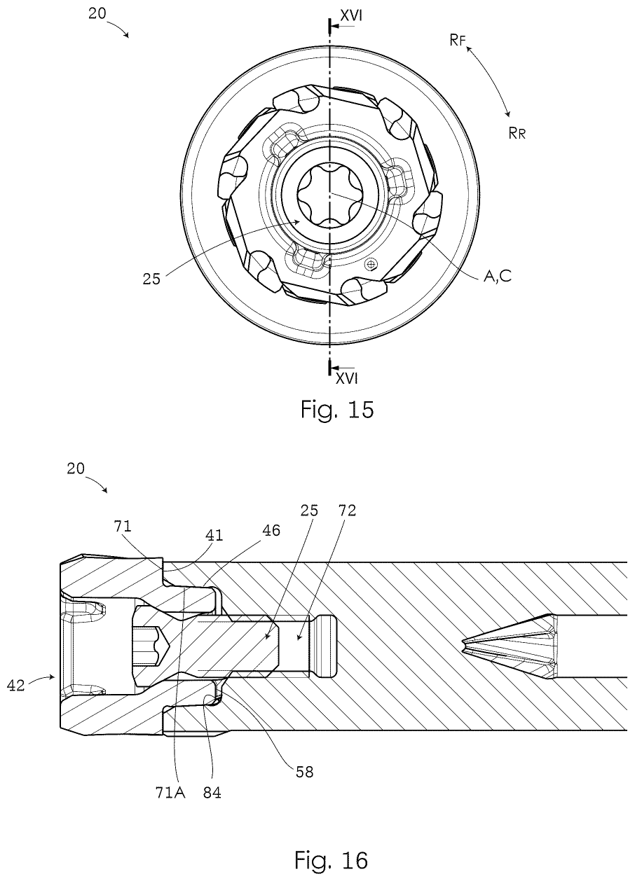

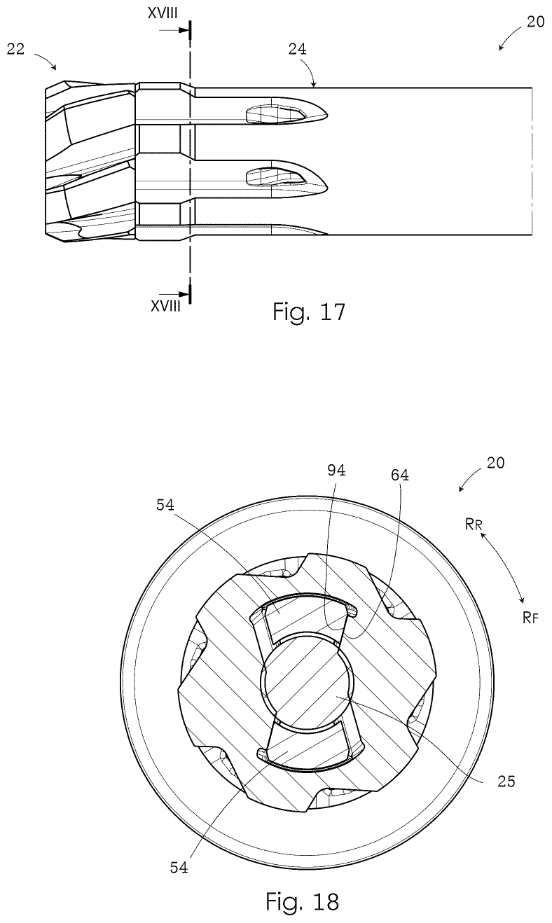

Referring to FIGS. 15-18, another aspect of the subject matter of the present application relates to a rotary cutting tool 20 that includes the replaceable cutting head 22 and tool holder 24 as defined herein above releasably attached by the fastening screw 25.

The rotary cutting tool 20 is adjustable between a released position and a locked position. In the released position of the rotary cutting tool 20, as shown in FIG. 2, the rotary cutting tool 20 is unassembled and the male coupling member 38 is located outside of the female coupling member 66.

Assembly of the rotary cutting tool 20 can be accomplished by performing the following steps. The mounting portion 28 of the replaceable cutting head 22 is placed in front of the holder pocket 79 of the tool holder 24. Next, the male coupling member 38 is inserted into the female coupling member 66 until each driven projection 54 initially enters a respective driving recess 80 (it may be required to rotate the replaceable cutting head 22 with respect to the tool holder 24 so that the at least two driven projections 54 are rotationally aligned with the at least two driving recesses 80). Then, the replaceable cutting head 22 is moved further towards tool holder 24 until the head abutment surface 46 comes into circumferential contact with the holder abutment surface 71A. Next, the fastening screw 25 is inserted through the head through hole 42 and initially threadingly engages with the holder internal threaded hole 72. Tightening of the fastening screw 25 causes the fastening screw 25 to urge the male coupling member 38 of the replaceable cutting head 22 further into the female coupling member 66 of the tool holder 24 until the conical head abutment surface 46 firmly abuts the conical forward holder abutment surface 71A, defining the locked position of the rotary cutting tool 22. The contact between the conical head abutment surface 46 and the conical forward holder abutment surface 71A can form a friction-fit. In the locked position of the rotary cutting tool 20, the replaceable cutting head 22 is removably attached to the tool holder 24 by the fastening screw 25 located in the head through hole 42 and being threadingly engaged with the holder internal threaded hole 72. The male coupling member 38 is located in the female coupling member 66 by the fastening screw 25 located in the head through hole 42. The fastening screw 25 and the holder internal threaded hole 72 are threadingly engaged with each other. The head central axis A and the holder longitudinal axis C are both co-incident (i.e., aligned) with each other. Each driven projection 54 is located in a respective driving recess 80, with the driven surface 64 abutting the driving surface 94. In accordance with some embodiments of the subject matter of the present application, the head axial abutment surface 41 can abut the holder axial abutment surface 71. Each projection top surface 58 can be spaced apart from a respective recess bottom surface 84. Each rotationally leading projection flank surface 60L can be spaced apart from a respective rotationally leading recess flank surface 88L. The head rearward surface 50 can be spaced apart from the female member bottom surface 68.

It should further be noted that a feature of the subject matter of the present application is that the torque transfer system (i.e., the location of driving and driven surfaces) is compact. For example, the torque transfer system is located centrally and in particular radially within the centering mechanism (i.e., the conically shaped head and holder abutment surfaces).

Although the subject matter of the present application has been described to a certain degree of particularity, it should be understood that various alterations and modifications could be made without departing from the spirit or scope of the invention as hereinafter claimed.

What is claimed is:

1. A replaceable cutting head (22), for rotary cutting operations, having a head central axis (A), defining opposite forward and rearward directions (D_{F}, D_{R}), and opposite rotationally forward and rearward directions (R_{F}, R_{R}) with the rotationally forward direction (R_{F}) being the cutting direction, the replaceable cutting head (22) comprising:
a forward portion forming a cutting portion (26) and a rearward portion forming a mounting portion (28); and
opposite head forward and rearward surfaces (48, 50) and a head peripheral surface (52) extending therebetween, the head forward surface (48) being located at the cutting portion (26) and the head rear surface (50) being located at the mounting portion (28);
a head through hole (42) comprising a through hole peripheral surface (44) which extends about a through hole central axis (E), and intersects the head forward and rearward surfaces (48, 50); wherein:
the mounting portion (28) comprises:
a male coupling member (38) protruding rearwardly from a head base surface (40), the head base surface (40) extending transversely with respect to the head central axis (A), and defining a boundary between the cutting portion (26) and the mounting portion (28); and
at least two angularly spaced apart driven projections (54) projecting from the head rearward surface (50), each driven projection (54) comprising a projecting wall (56) comprising two opposite and angularly spaced apart projection flank surfaces (60L, 60T) including a rotationally leading and a rotationally trailing projection flank surface (60L, 60T), the rotationally trailing projection flank surface (60T) comprising a driven surface (64), for opposing a torque about the head central axis (A); wherein:
the head base surface (40) comprises a head axial abutment surface (41); and
the male coupling member (38) comprises a non-cylindrical, conically shaped head abutment surface (46).

2. The replaceable cutting head (22) according to claim 1, wherein:
each projecting wall (56) further comprises opposite radially outward and inward projection surfaces (62O, 62I) which connect the rotationally leading trailing projection flank surface (60L, 60T); and
the radially outward and inward projection surfaces (62O, 62I) merge smoothly with the conically shaped head abutment surface (46) and the through hole peripheral surface (44), respectively.

3. The replaceable cutting head (22) according to claim 1, wherein:
each driven surface (64) is planar.

4. The replaceable cutting head (22) according to claim 3, wherein:
the head rearward surface (50) defines a head rearward plane (HP1) oriented perpendicular to the head central axis (A);
each planar driven surface (64) forms an external driven axial angle (μ1) with the head rearward plane (HP1); and
the driven axial angle (μ1) fulfills the condition: 100°≤μ1≤130°.

5. The replaceable cutting head (22) according to claim 4, wherein:
the driven axial angle (μ1) fulfills the condition: μ1=115°.

6. The replaceable cutting head (22) according to claim 1, wherein:
in a cross-sectional view of the replaceable cutting head (22) taken in a head radial plane (RP1) oriented perpendicular to the head central axis (A) and extending through a given driven surface (64):
the given driven surface (64) defines an imaginary straight driven line (DL1) which intersects the head through hole (42).

7. The replaceable cutting head (22) according to claim 6, wherein:
the given driven surface (64) comprises a radially outermost driven point (PO1) and a radially innermost driven point (PI1), the radially outermost driven point (PO1) being angularly offset from the radially innermost driven point (PI1), relative to the head central axis (A), by a non-zero acute driven offset angle (β1);
an imaginary straight driven radial line (RL1) extends from the head central axis (A) and intersects the radially outermost driven point (PO1), the imaginary straight driven radial line (RL1) forming a non-zero acute driven radial angle (ε1) with the given driven surface (64).

8. The replaceable cutting head (22) according to claim 7, wherein:
the head radial plane (RP1) extends through a forwardmost portion of the given driven surface (64); and
the driven radial angle (81) fulfills the condition: 15°≤ε1≤25°.

9. The replaceable cutting head (22) according to claim 7, wherein:
the radially outermost driven point (PO1) is angularly offset from the radially innermost driven point (PI1), relative to the head central axis (A), in the rotationally forward direction (R_{F}).

10. The replaceable cutting head (22) according to claim 1, wherein:
the head axial abutment surface (41) is planar and oriented perpendicular to the head central axis (A); and
the head axial abutment surface (41) extends entirely circumferentially about the male coupling member (38).

11. The replaceable cutting head (22) according to claim 1, wherein:
the at least two driven projections (54) are identical.

12. The replaceable cutting head (22) according to claim 1, wherein:
the male coupling member (38) comprises exactly two angularly spaced apart driven projections (54).

13. The replaceable cutting head (22) according to claim 1, wherein:
each driven projection (54) subtends a maximum projection angle (θ1) at the head central axis (A); and
the maximum projection angle (θ1) fulfills the condition: 100°≤θ1≤130°.

14. The replaceable cutting head (22) according to claim 1, wherein:
the cutting portion (26) comprises at least two peripheral cutting edges (30) defining an outer cutting diameter (O); and
the outer cutting diameter (O) fulfills the condition: 6 mm<O<8 mm.

15. The replaceable cutting head (22) according to claim 1, wherein:
the driven projections (54) have a projection height (H) as measured in a direction along the head central axis (A);
the male coupling member (38) has a male coupling member height (H′) as measured between the head rearward surface (50) and the head base surface (40) in the direction along the head central axis (A); and
the projection height (H) fulfills the condition: 0.25H′≤H≤0.50H′.

16. The replaceable cutting head (22) according to claim 15, wherein:
the cutting portion (26) has a cutting portion height (H″) as measured between the head forward surface (48) and the head base surface (40) in the direction along the head central axis (A); and
the male coupling member height (H′) is less than the cutting portion height (H″).

17. A tool holder (24), having a holder longitudinal axis (C) defining opposite forward and rearward directions (D_{F}, D_{R}), and opposite rotationally forward and rearward directions (R_{F}, R_{R}) with the rotationally forward direction (R_{F}) being the cutting direction, the tool holder (24) comprising a holder pocket (79) extending rearwardly from a holder forward surface (70), the holder forward surface (70) extending transversely with respect to the holder longitudinal axis (C); wherein:
the holder pocket (79) comprises:
a female coupling member (66) recessed in the holder forward surface (70), the female coupling member (66) comprising:
a non-cylindrical, conically shaped holder abutment surface (71A); and
a female member bottom surface (68);
at least two angularly spaced apart driving recesses (80) recessed in the female member bottom surface (68), each driving recess (80) comprising a recess circumferential wall (82) comprising two opposite and angularly spaced apart recess flank surfaces (88L, 88T) including a rotationally leading and a rotationally trailing recess flank surface (88L, 88T), the rotationally trailing recess flank surface (88T) comprising a driving surface (94), for providing a torque about the holder longitudinal axis (C); and
a holder internal threaded hole (72) recessed in the female member bottom surface (68); wherein:
the holder forward surface (70) comprises a holder axial abutment surface (71).

18. The tool holder (24) according to claim 17, wherein:
each recess circumferential wall (82) further comprises a radially outward recess surface (90O) which connects the rotationally leading and trailing recess flank surfaces (88L, 88T);
the radially outward recess surface (90O) extends to, and merges smoothly with, the conically shaped holder abutment surface (71A); and
each driving recess (80) opens out to the holder internal threaded hole (72) at a radially inward recess opening (92) opposite the radially outward recess surface (90O).

19. The tool holder (24) according to claim 17, wherein:
each driving surface (94) is planar.

20. The tool holder (24) according to claim 17, wherein:
the female member bottom surface (68) defines a female member bottom plane (FP2) oriented perpendicular to the holder longitudinal axis (C);
each planar driving surface (94) forms an internal driving axial angle (μ2) with the female member bottom plane (FP2); and
the driving axial angle (μ2) fulfills the condition: 100°≤μ2≤130°.

21. The tool holder (24) according to claim 20, wherein:
the driving axial angle (μ2) fulfills the condition: μ2=115°.

22. The tool holder (24) according to claim 17, wherein:
in a cross-sectional view of the tool holder (24) taken in a holder radial plane (RP2) oriented perpendicular to the holder longitudinal axis (C) and extending through a given driving surface (94):
the given driving surface (94) defines an imaginary straight driving line (DL2) which intersects the holder internal threaded hole (72).

23. The tool holder (24) according to claim 22, wherein:
the given driving surface (94) comprises a radially outermost driving point (PO2) and a radially innermost driving point (PI2), the radially outermost driving point (PO2) being angularly offset from the radially innermost driving point (PI2), relative to the holder longitudinal axis (C), by a non-zero acute driving offset angle (β2);
an imaginary straight driving radial line (RL2) extends from the head central axis (A) and intersects the radially outermost driving point (PO2), the imaginary straight driving radial line (RL2) forming a non-zero acute driving radial angle (82) with the given driving surface (94).

24. The tool holder (24) according to claim 23, wherein:
the holder radial plane (RP2) extends through a forwardmost portion of the given driving surface (94); and
the driving radial angle (ε2) fulfills the condition: 15°≤ε2≤25°.

25. The tool holder (24) according to claim 23, wherein:
the radially outermost driving point (PO2) is angularly offset from the radially innermost driving point (PI2), relative to the holder longitudinal axis (C), in the rotationally forward direction (R_{F}).

26. The tool holder (24) according to claim 17, wherein:
the holder axial abutment surface (71) is planar and oriented perpendicular to the holder longitudinal axis (C); and
the holder axial abutment surface (71) extends entirely circumferentially about the female coupling member (66).

27. The tool holder (24) according to claim 17, wherein:
the at least two driving recesses (80) are identical.

28. The tool holder (24) according to claim 17, wherein:
the holder pocket (79) comprises exactly two angularly spaced apart driving recesses (80).

29. The tool holder (24) according to claim 17, wherein:
each driving recess (80) subtends a maximum recess angle (θ2) at the holder longitudinal axis (C); and
the maximum recess angle (θ2) fulfills the condition: 100°≤θ2≤130°.

30. The tool holder (24) according to claim 17, wherein:
each driving recess (80) comprises a recess bottom surface (84) bounded by the recess circumferential wall (82);
the driving recesses (80) have a recess depth (D) as measured in a direction along the holder longitudinal axis (C);
the female coupling member (66) has a female coupling member depth (D′) as measured between the holder forward surface (70) and the female member bottom surface (68) in the direction along the holder longitudinal axis (C); and
the recess depth (D) fulfills the condition: 0.25D′≤D≤0.50D′.

31. A rotary cutting tool (20) comprising:
a replaceable cutting head (22) in accordance with claim 1;
a tool holder (24) in accordance with claim 17; and
a fastening screw (25); wherein:
the male coupling member (38) is located in the female coupling member (66), with the head abutment surface (46) abutting the holder abutment surface (71A);
each driven projection (54) is located in a respective driving recess (80), with the driven surface (64) abutting the driving surface (94); and
the replaceable cutting head (22) is removably attached to the tool holder (24) by the fastening screw (25) located in the head through hole (42) and being threadingly engaged with the holder internal threaded hole (72).

32. The rotary cutting tool (20) according to claim 31, wherein in a locked position of the cutting tool (20), the head axial abutment surface (41) abuts the holder axial abutment surface (71).

33. The rotary cutting tool (20) according to claim 31, wherein in a locked position of the cutting tool (20), each rotationally leading projection flank surface (60L) is spaced apart from a respective rotationally leading recess flank surface (88L).

34. The rotary cutting tool (20) according to claim 31, wherein in a locked position of the cutting tool (20), the head rearward surface (50) is spaced apart from the female member bottom surface (68).

35. The rotary cutting tool (20) according to claim 31, wherein the rotary cutting tool (20) is a reamer.
